(19) United States
(12) Patent Application Publication
(10) Pub. No.: US 2014/0293339 A1
(43) Pub. Date: Oct. 2, 2014

(54) IMAGE PROCESSING SYSTEM, IMAGE PROCESSING APPARATUS AND REMOTE TERMINAL

(71) Applicant: KONICA MINOLTA, INC., Tokyo (JP)

(72) Inventor: Yasunori Satou, Tokyo (JP)

(73) Assignee: KONICA MINOLTA, INC., Tokyo (JP)

(21) Appl. No.: 14/224,695

(22) Filed: Mar. 25, 2014

(30) Foreign Application Priority Data
Mar. 27, 2013 (JP) 2013-066341

(51) Int. Cl. H04N 1/00

(52) U.S. Cl. CPC H04N 1/00488; H04N 1/00408; H04N 1/00392
USPC 358/1.15

(57) ABSTRACT

An image processing system includes an image processing apparatus and a remote terminal. The control section of the image processing apparatus is configured to, on executing a process in response to an instruction received through the operating section of the image processing apparatus, operate the output section of the image processing apparatus to output a notice corresponding to the process. The control sections of the image processing apparatus and the remote terminal are configured to, on the control section of the image processing apparatus executing a process in response to an instruction received through the operating section of the remote terminal, operate the output section of the remote terminal to output a notice corresponding to the process, and operate the output section of the image processing apparatus not to output the notice or operate the output section of the remote terminal not to output a notice corresponding to a process other than the process.

This application is based on Japanese Patent Application No. 2013-066341 filed on Mar. 27, 2013, in the Japan Patent Office, the entire content of which is hereby incorporated by reference.

### TECHNICAL FIELD

The present invention relates to an image processing system which includes an image processing apparatus capable of outputting a sound and displaying a screen corresponding to processes, and a remote terminal capable of performing a remote operation for the image processing apparatus.

### BACKGROUND

In some of image processing apparatuses such as a facsimile (hereafter, described as a FAX) apparatus and a MFP (Multi-Function Peripheral), a user is enabled to grasp the situation of a process with a sound (for example, a FAX communication sound, an operation sound, a process completion notification sound and a guidance voice) outputted in accordance with the process, or with a screen (for example, a FAX communication screen and a printing screen) displayed in accordance with the process.

Further, in recent years, such an image processing apparatus includes additionally a function to enable a remote operation with a terminal such as a smart phone and a tablet terminal (hereafter, called as “remote terminal”). Accordingly, when the image processing apparatus and the remote terminal are connected to each other through a wireless LAN (Local Area Network) or the like, a remote operation can be performed for the image processing apparatus installed at a distant location.

As a technique with regard to the control of a system in which a plurality of apparatuses is connected via a LAN, though the technique is not related to the above-mentioned remote operation, for example, Japanese Unexamined Patent Publication (JP-A) No. H5-244292 discloses the following LAN system. The LAN system includes a server having an answering phone function and an ISDN terminal function, and a client terminal having a codec conversion function and a function to make a speaker to output a sound based on sound signals. In the LAN system, the server is configured to receive an audio message and to mail the received audio message to the client terminal via the LAN, and the client terminal is configured to make a speaker output the audio message.

The technique of JP-A No. H5-244292 is configured to control the client terminal to output a sound received by the server, and is not configured to control a remote terminal to reproduce a sound which is outputted from an image processing apparatus in accordance with a process instructed by the remote terminal. Accordingly, a user being operating the remote terminal cannot grasp the situation of the process (whether a FAX communication is started normally, whether the FAX communication is ended normally, and the like) being executed at the image processing apparatus. As a result, the user needs time and labor to confirm the situation with a sound at a location near the image processing apparatus.

Further, the same is true with regard to an indication on a screen. That is, the remote terminal cannot display thereon a screen which is displayed on the image processing apparatus in accordance with the process instructed by the remote terminal. Accordingly, the user being operating the remote terminal cannot grasp the situation of the process (how much the FAX communication is advancing, and the like) being executed at the image processing apparatus. As a result, the user needs time and labor to confirm the situation on the screen at a place near the image processing apparatus.

Moreover, in an image processing apparatus in which a plurality of processes can be executed simultaneously in parallel to each other, regardless of the contents and kind of a process, if the output of a sound and the indication of a screen are performed in accordance with the process at one side of the image processing apparatus and the remote terminal, or if the output of a sound and the indication of a screen in accordance with each process are performed at both sides of the image processing apparatus and the remote terminal, there is a problem that it becomes impossible to grasp the situation of the process at an apparatus side (an image processing apparatus side or a remote terminal side) having instructed the process. The present invention seeks to solve the problems.

### SUMMARY

There are disclosed illustrative image processing systems, image processing apparatuses and remote terminals as embodiments of the present invention.

An illustrative image processing system reflecting one aspect of the present invention is an image processing system comprising: an image processing apparatus and at least one remote terminal which can perform a remote control for the image processing apparatus. The image processing apparatus comprises a control section configured to execute a plurality of processes, an operating section configured to receive instructions for the processes and an output section configured to output a notice corresponding to each of the processes. The remote terminal comprises an operating section configured to receive instructions for processes to be executed in the image processing apparatus, an output section configured to output a notice corresponding each of the processes, and a control section. The control section of the image processing apparatus is configured to, on the control section of the image processing apparatus executing a process in response to an instruction received through the operating section of the image processing apparatus, operate the output section of the image processing apparatus to output a notice corresponding to the process executed in response to the instruction received through the operating section of the image processing apparatus. The control section of the image processing apparatus and the control section of the remote terminal are configured to, on the control section of the image processing apparatus executing a process in response to an instruction received through the operating section of the remote terminal, operate the output section of the remote terminal to output a notice corresponding to the process executed in response to the instruction received through the operating section of the remote terminal, and operate the output section of the image processing apparatus not to output the notice corresponding to the process executed in response to the instruction received through the operating section of the remote terminal or operate the output section of the remote terminal not to output a notice corresponding to a process other than the process executed in response to the instruction received through the operating section of the remote terminal.

An illustrative image processing apparatus reflecting one aspect of the present invention is an image processing apparatus which can connect with at least one remote terminal for performing a remote operation for the image processing apparatus. The image processing apparatus comprises: a control section configured to execute a plurality of processes, an operating section configured to receive instructions for the processes and an output section configured to output a notice corresponding to each of the processes. The control section is configured to, on executing a process in response to an instruction received through the operating section, operate the output section to output a notice corresponding to the process executed in response to the instruction received through the operating section, and on executing a process in response to an instruction received from the remote terminal, operate the remote terminal to output a notice corresponding to the process executed in response to the instruction received from the remote terminal and operate the output section not to output the notice corresponding to the process executed in response to the instruction received from the remote terminal.

An illustrative remote terminal reflecting one aspect of the present invention is a remote terminal which can perform a remote control for an image processing apparatus. The image processing apparatus is configured to execute a plurality of processes and includes an output section configured to output a notice corresponding to each of the processes. The remote terminal comprises an operating section configured to receive instructions for processes to be executed in the image processing apparatus, an output section configured to output a notice corresponding each of the processes, and a control section configured to, on the image processing apparatus executing a process in response to an instruction received through the operating section, acquire a notice corresponding to the process from the image processing apparatus and operate the output section of the remote terminal to output the notice.

Other features of illustrative embodiments will be described below.

### BRIEF DESCRIPTION OF THE DRAWINGS

Embodiments will now be described, by way of example only, with reference to the accompanying drawings which are meant to be exemplary, not limiting, and wherein like elements numbered alike in several figures, in which:

FIG. 1 is an illustration showing schematically a constitution of an image processing system in relation to the first example;

FIG. 2 is a block diagram showing a constitution of an image processing apparatus in relation to the first example;

FIG. 3 is a block diagram showing a constitution of a remote terminal in relation to the first example;

FIG. 4 is a flowchart showing processing at the remote terminal in relation to the first example;

FIG. 5 is a flowchart showing processing at the image processing apparatus in relation to the first example;

FIGS. 6A to 6C are illustrations showing schematically processing at the remote terminal in relation to the first example;

FIGS. 7A to 7D are an illustrations showing schematically processing at the image processing apparatus in relation to the first example;

FIG. 8 is a flowchart showing processing at the remote terminal in relation to the second example;

FIG. 9 is a flowchart showing processing at the image processing apparatus in relation to the second example;

FIGS. 10A to 10E are illustrations showing schematically processing at the remote terminal in relation to the second example;

FIGS. 11A to 11C are illustrations showing schematically processing at the image processing apparatus in relation to the second example; and

FIG. 12 is an illustration showing schematically another processing of the image processing system in relation to the second example.

### DETAILED DESCRIPTION

Illustrative embodiments of image processing systems, image processing apparatuses and remote terminals will be described with reference to the drawings. It will be appreciated by those of ordinary skill in the art that the description given herein with respect to those figures is for exemplary purposes only and is not intended in any way to limit the scope of potential embodiments may be resolved by referring to the appended claims.

According to the image processing system, the image processing apparatus, and the remote terminal of the present invention, a user having instructed a process can grasp the situation of the process appropriately.

The reasons why a user having instructed a process can grasp the situation of the process appropriately are as follows. That is, according to one reason, when a process is executed in an image processing apparatus in response to an instruction given in the image processing apparatus, a notice corresponding to the instructed process is outputted by the output section of the image processing apparatus. On the other hand, when a process is executed in the image processing apparatus in response to an instruction given in a remote terminal, a notice corresponding to the instructed process is outputted by the output section of the remote terminal, and the notice corresponding to the instructed process is not outputted by the output section of the image processing apparatus or a notice corresponding to a process other than the instructed process is not outputted by the output section of the remote terminal. Further, according to another reason, when a plurality of processes are executed, a notice corresponding to a process other than a process instructed given in a remote terminal is outputted by the output section the image processing apparatus. In addition, when remote operations are performed by a plurality of remote terminals, only a notice corresponding to a process instructed by one of the remote terminals is outputted by the one of the remote terminals which has given the instruction.

As shown in the descriptions about the background art, with the use of a remote terminal, it becomes possible to perform a remote operation (an operation performed remotely from a distant location) for an image processing apparatus installed at a distant location. However, the remote terminal in the background art did not perform an output of a sound and an indication of a screen in response to a process instructed by a remote terminal, which made a user difficult to grasp the situation of the process unless the user goes near to the image processing apparatus and checks the situation with a sound and a screen.

Further, in an image processing apparatus in which a plurality of processes can be executed simultaneously in parallel to each other, if the output of a sound and the indication of a screen are performed in response to all of the processes at one side of the image processing apparatus and the remote terminal, or if the output of a sound and the indication of a screen are performed in response to each process at both sides of the image processing apparatus and the remote terminal, it makes a user difficult to grasp the situation of a process at an apparatus side having instructed the process (at an image processing apparatus side or a remote terminal side), which was a problem.

Then, one embodiment of the present invention provides an image processing apparatus and a remote terminal which are configured as follows. In response to receiving an instruction for executing a process, the control section of the image processing apparatus judges whether the instruction is given by the image processing apparatus or by a remote terminal. As a result of the judgment, when the instruction has been made from the image processing apparatus, the operating section of the image processing apparatus operates the output section of the image processing apparatus to output information created according to the instructed process, where the information is one of a notification sound and a notification screen (including a simple message), which are collectively called as “notice”. On the other hand, when the instruction has been made from the remote terminal, the operating section of the remote terminal operates the output section of the remote terminal to output the notice according to the instructed process. Further, when the instruction has been made from the remote terminal, the operating section of the image processing apparatus operates the output section of the image processing apparatus not to output the notice according to the instructed process or the operating section of the remote terminal operates the output section of the remote terminal to output the notice according to a process other than the instructed process.

With this, a user of the remote terminal can confirm a sound outputted and a screen displayed corresponding to a process executed in response to an instruction given through the remote terminal, on the remote terminal. Therefore, even in the case where a remote operation for an image processing apparatus is performed at a place distant from the image processing apparatus, it allows a user to grasp surely the situation of a process which is instructed by the remote terminal and executed in the image processing apparatus in response to the instruction. Further, the output of a sound and the indication of a screen corresponding to the process instructed by a remote terminal may not be performed on the image processing apparatus, and the output of a sound and the display of a screen corresponding to a process other than a process instructed by a remote terminal may not be performed at the remote terminal side. Accordingly, the situation of a process can be grasped appropriately by preventing the mixture of processes.

### EXAMPLES

### First Example

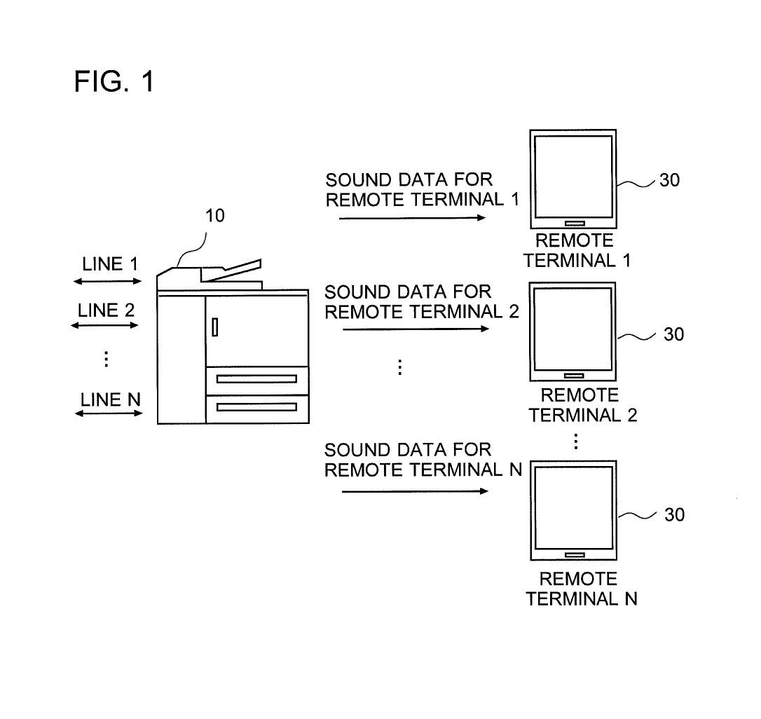

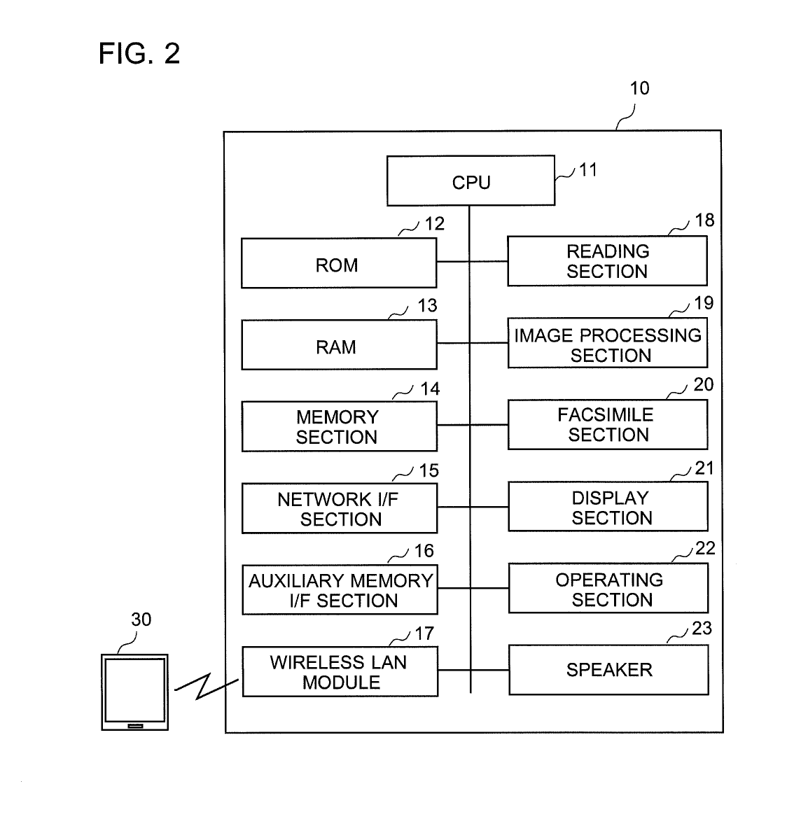

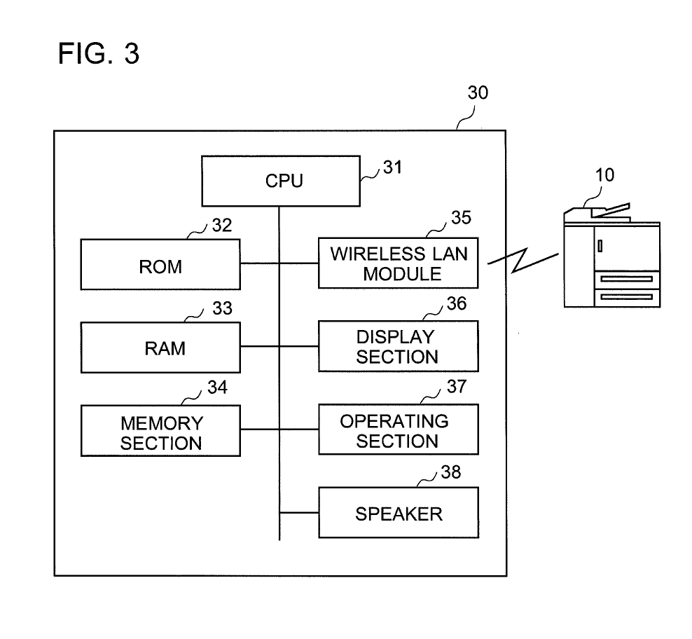

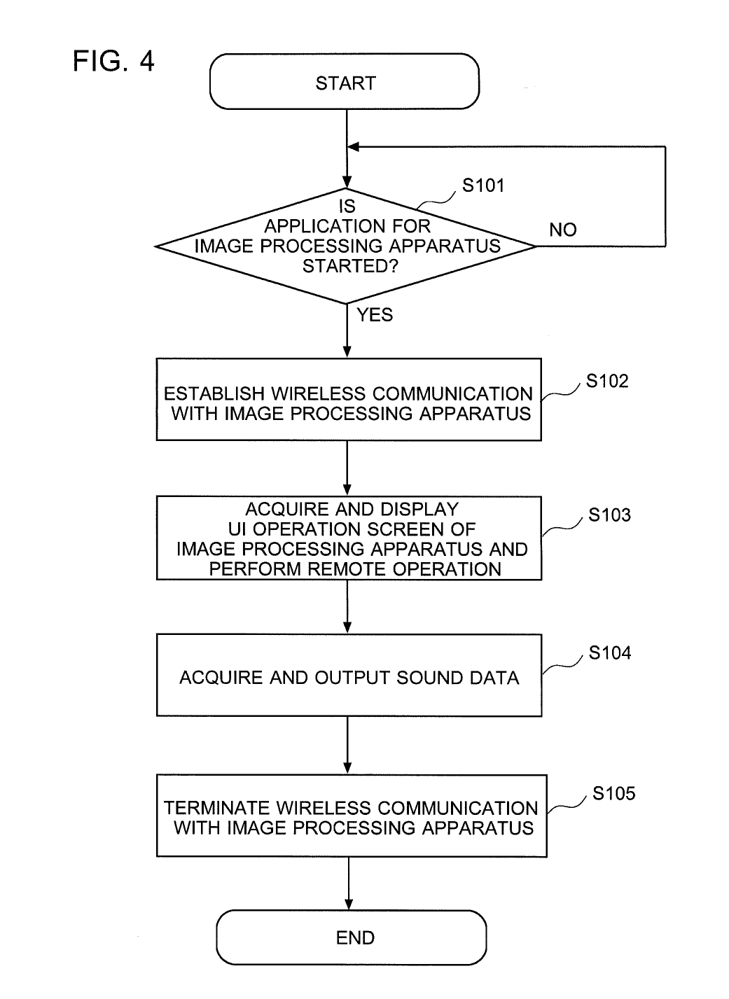

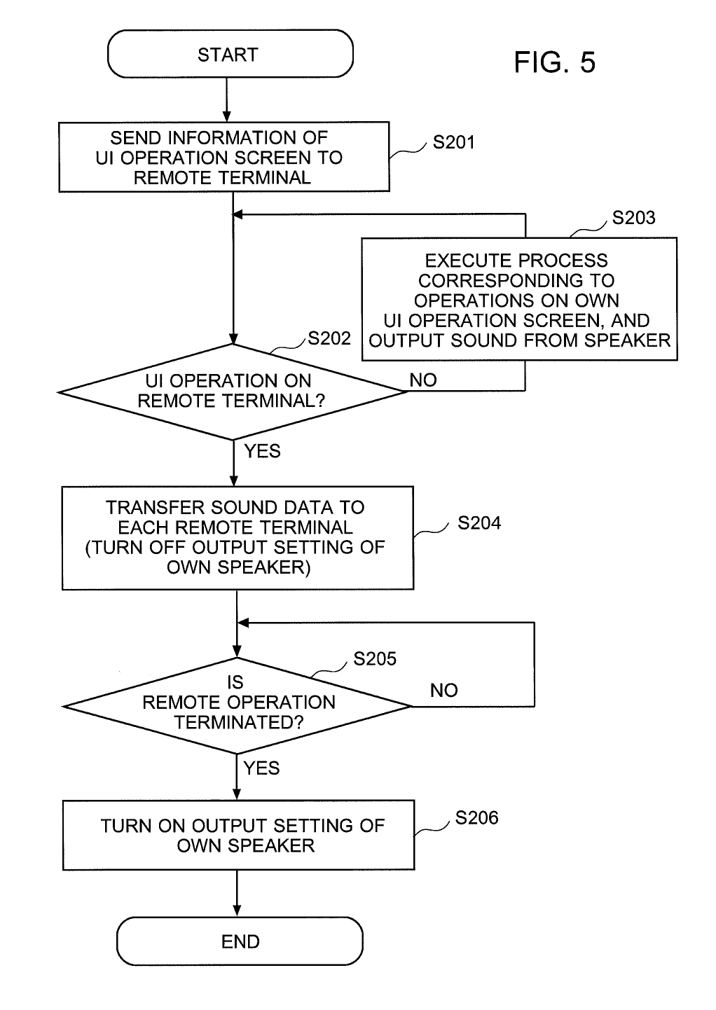

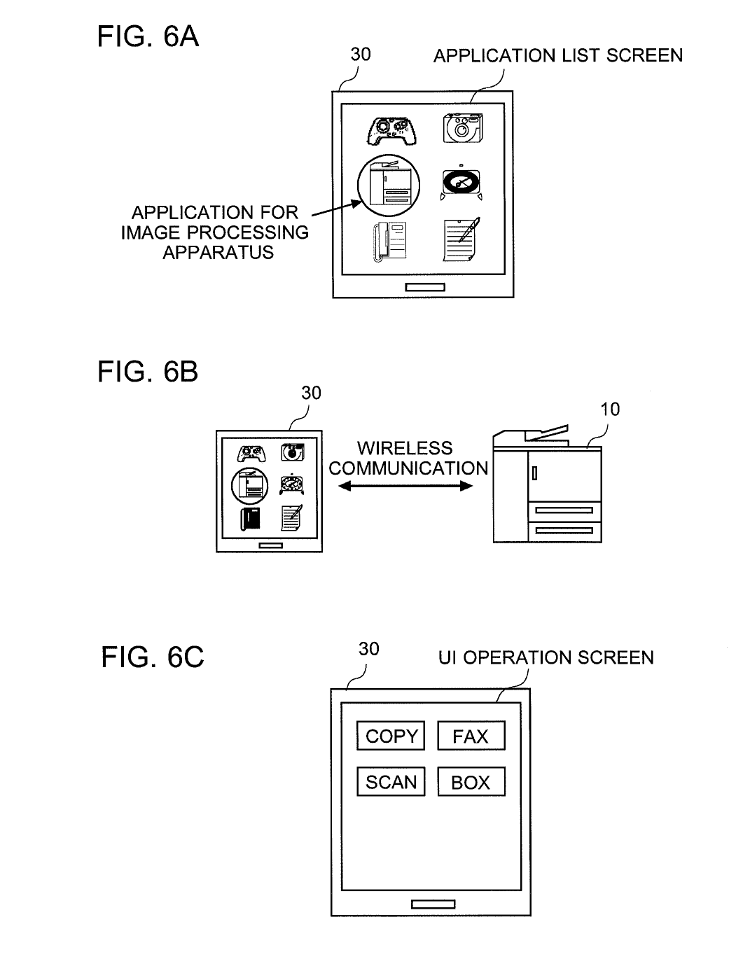

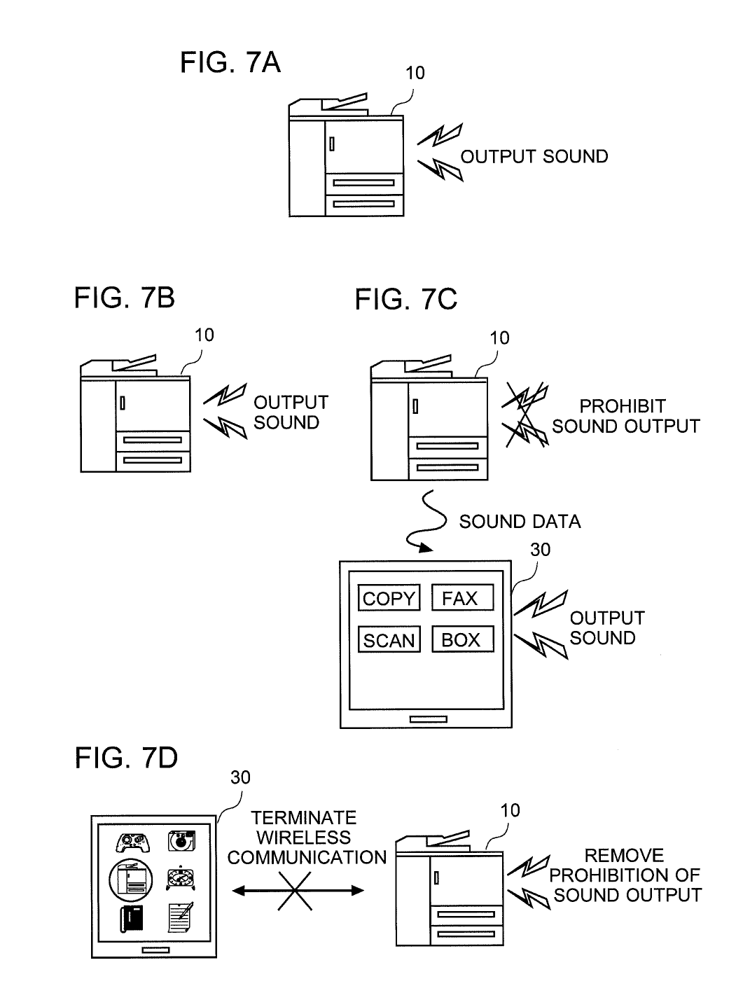

In order to describe the above-mentioned embodiments of the present invention in more details, description will be given to an image processing system, an image processing apparatus and a remote terminal in relation to the first example of the present invention with reference to FIGS. 1 to 7. FIG. 1 is an illustration showing schematically a constitution of an image processing system of the present example, FIG. 2 is a block diagram showing a constitution of an image processing apparatus of the present example and FIG. 3 is a block diagrams showing a constitution of a remote terminal of the present example. Further, FIGS. 4 and 5 are flowcharts showing processing of the remote terminal and the image processing system respectively, and FIGS. 6A to 6C and 7A to 7D are illustrations showing schematically processing of the remote terminal and the image processing system respectively.

As shown in FIG. 1, an image processing system of the present example includes an apparatus becoming a target of a remote operation and one or multiple terminals configured to perform a remote operation, where in the present example, the apparatus becoming a target of a remote operation is referred to as an image processing apparatus 10, i.e., a FAX (facsimile) apparatus and a MFP, and the one or multiple terminals are referred to as a remote terminal(s) 30. The image processing apparatus 10 and the one or multiple remote terminals 30 are connected to each other via a wireless communication network, i.e., a wireless LAN established by specifications, such as Ethernet (registered trademark), a token ring, and a FDDI (Fiber-Distributed Data Interface). Here, FIG. 1 shows a configuration in which the image processing apparatus 10 and the one or multiple remote terminals 30 are directly connected to each other via a wireless communication network. However, the image processing apparatus 10 and the one or multiple remote terminals 30 may be connected to each other via a device such as a router. Hereafter, each of the image processing apparatus and the remote terminal will be described.

### Image Processing Apparatus:

As shown in FIG. 2, the image processing apparatus 10 of the present example includes a CPU (Central Processing Unit) 11, a ROM (Read Only Memory) 12, a RAM (Random Access Memory) 13, a memory section 14, a network I/F (interface) section 15, an auxiliary memory I/F section 16, a wireless LAN module 17, a reading section 18, an image processing section 19, a facsimile section 20, a display section 21, an operating section 22 and a speaker 23.

The CPU 11 is configured to read out a control program from the memory section 14 such as the ROM 12 and a HDD (Hard Disk Driver), to develop it into the RAM 13, and to execute it. In particular, in the present example, the CPU 11 reads out from the ROM 12 and the memory section 14 a Web application which provides a Web service to enable operations for the image processing apparatus 10 on a Web browser executed at a terminal connected to the image processing apparatus 10, and the CPU 11 develops the Web application into the RAM 13 and executes it, whereby the image processing apparatus 10 works additionally as a Web server.

A control section is constituted by the CPU 11, the ROM 12, the RAM 13 and the memory section 14. The control section is configured to create a screen used to allow a user to operate the image processing apparatus 10 (hereafter, referred to as a UI (User Interface) operation screen), to display the screen on the display section 21 of the image processing apparatus 10 and on the display section of the remote terminal 30, and to receive an operation performed on the UI operation screen. Further, upon receipt of an operation, the control section judges whether the operation is performed on the UI operation screen displayed on image processing apparatus 10 or on the UI operation screen displayed on the remote terminal 30. Then, in the case of having judged such that the operation has been performed on the UI operation screen displayed on the image processing apparatus 10, the control section operates the speaker 23 of the image processing apparatus 10 to output a sound or a voice corresponding to the process. On the other hand, in the case of having judged such that the operation has been performed on the UI operation screen displayed on the remote terminal 30, the control section transfers the data of a sound or a voice (hereafter, referred to as “sound data”) corresponding to the process to the remote terminal 30. Furthermore, if needed, the control section performs control to turns off the output setting of the speaker 23 of the image processing apparatus 10.

The network I/F section 15 includes a FAX communication modem to be connected to a telephone line, and is configured to perform modulation and demodulation processing for signals for a FAX data communication.

The auxiliary memory I/F section 16 is configured to perform connection with an external memory device, if needed.

The wireless LAN module 17 includes a NIC (Network Interface Card), and is configured to enable network communication with the remote terminals 30. Further, the wireless LAN module 17 is configured to send information of the UI operation screen and sound data corresponding to a process executed in the image processing apparatus 10 to the remote terminal 30, and to receive operation information of the UI operation screen from the remote terminal 30. Here, in the present example, the image processing apparatus 10 and the remote terminals 30 are constituted to be connected to each other via a wireless LAN. However, the connecting method should not be limited to the wireless LAN. For example, Bluetooth (registered trademark) being one of short distance wireless communication specifications and the like may be also used. In that case, a Bluetooth (registered trademark) communication module may be utilized in place of the wireless LAN module 17.

The reading section 18 is configured to read image data optically from a document placed on a document stand, and includes a light source to scan a document, an image sensor, such as CCDs (Charge Coupled Devices) to convert light reflected from the document into electrical signals, and an A-D converter to perform A/D conversion for the electrical signals.

The image processing section 19 is configured to rasterize the data of each page of document data received from the remote terminal 30 and other client terminals so as to convert them into image data, and to perform image processing, such as edge enhancement processing, smoothing processing, color conversion processing, and the like for image data read out by the reading section 18 and image data rasterized based on a print job.

The facsimile section 20 is configured to perform FAX communication control and codec and de-codec processing for the received image data. Further, in the case where the image processing apparatus 10 is constituted as a part of a MFP, the facsimile section 20 is configured to perform communication control with the MFP main unit.

The display section 21 includes a LCD (Liquid Crystal Display), and is configured to display a UI operation screen and an output setup screen of the speaker 23. The operating section 22 includes a hard key and a touch sensor constituted by lattice-shaped transparent electrodes formed on the display section 21, and is configured to receive a user's operation with regard to an instruction of a process to be executed in the image processing apparatus 10, an output setting of the speaker 23, and the like.

The speaker 23 is an output section to output a notice (in the present example, a sound and/or a voice), and is configured to output a sound and/or a voice corresponding to a process executed in the image processing apparatus 10 (for example, a FAX communication sound, an operation sound, a process completion notifying sound, a guidance voice, and the like).

### Remote Terminal:

As shown in FIG. 3, the remote terminal 30 of the present example includes a CPU 31, a ROM 32, a RAM 33, a memory section 34, a wireless LAN module 35, a display section 36, an operating section 37 and a speaker 38.

The CPU 31 is configured to read out a control program from the memory section 34 such as the ROM 32 and a HDD, to develop it into the RAM 13, and to execute it. In particular, in the present example, the CPU 31 reads out from the ROM 32 and the memory section 34 a Web application which enables operations for the image processing apparatus 10 on a Web browser, and the CPU 11 develops the Web application into the RAM 13 and executes it, whereby the CPU 31 works as a Web client.

A control section is constituted by the CPU 31, the ROM 32, the RAM 33 and the memory section 34. Upon receipt of sound data from the image processing apparatus 10, the control section controls the speaker 38 to output a sound based on the sound data.

The wireless LAN module 35 includes a NIC, and is configured to enable communication with the image processing apparatus 10. Further, the wireless LAN module 35 is configured to receive information of the UI operation screen and sound data from the image processing apparatus 10, and to send operation information of the UI operation screen to the image processing apparatus 10. Here, as mentioned above, the connecting method of connecting the image processing apparatus 10 and the remote terminals 30 should not be limited to the wireless LAN. Bluetooth (registered trademark) and the like may be also used. In that case, a Bluetooth (registered trademark) communication module may be utilized in place of the wireless LAN module 35.

The display section 36 includes a LCD, and is configured to display a list screen of application programs capable of acting in a remote terminal 30, a UI operation screen to be used to perform a remote operation for the image processing apparatus 10, and the like. The operating section 37 includes a hard key and a touch sensor constituted by lattice-shaped transparent electrodes formed on the display section 36, and is configured to allow a user to select an application program on the list screen, give an instruction on the UI operation screen for a process to be executed in the image processing apparatus 10, and the like.

The speaker 38 is an output section to output a notice (in the present example, a sound and/or a voice), and is constituted to issue a sound and/or a voice corresponding to a process executed in the image processing apparatus 10 (for example, a FAX communication sound, an operation sound, a process completion notifying sound, a guidance voice, and the like) based on the sound data sent from the image processing apparatus 10.

Here, the constitution shown in each of FIG. 2 and FIG. 3 is one example, and in any constitution, the image processing apparatus 10 and the remote terminal 30 can communicate with each other via wireless connection, and each of the image processing apparatus 10 and the remote terminal 30 includes a speaker so as to output a sound to be outputted by the speaker of the image processing apparatus 10, by the speaker of the remote terminal 30.

Hereafter, the actions of the image processing system of the present example will be described. First, the actions of the remote terminal 30 of the present example are described with reference to a flowchart shown in FIG. 4 and schematic diagrams shown in FIGS. 6A to 6C. In the control section of the remote terminal 30, the CPU 31 is configured to execute a control program stored in the ROM 32 or the memory section 34 such as the HDD, thereby realizing the processing of the flowchart shown in FIG. 4.

A user operates the operating section 37 so as to start the application for the image processing apparatus. For example, the operating section 37 controls the display section 36 to display an application list screen shown in FIG. 6A, and the user selects a picture of the image processing apparatus 10 (the picture enclosed with the circle in FIG. 6A) from the application list. Then, the control section of the remote terminal 30 starts the application for an image processing apparatus (YES at S101).

Next, as shown in FIG. 6B, the control section establishes wireless communication with the image processing apparatus 10 by using the wireless LAN module 35 (S102). Successively, as shown in FIG. 6C, the control section acquires information of the UI operation screen from the image processing apparatus 10, and controls the display section 36 to display the UI operation screen. Then the control section performs a remote operation for the image processing apparatus 10 (for example, FAX transmission or the like) in response to a user's operation performed on the UI operation screen (S103). At this time, the control section acquires sound data corresponding to a process instructed by the remote operation from the image processing apparatus 10, and operates the speaker 38 to output a sound or a voice based on the sound data (S104). In concrete terms, when FAX transmission is instructed by a remote operation, the control section acquires from the image processing apparatus 10 the sound data of a FAX notification sound corresponding to the FAX transmission executed in the image processing apparatus 10 in response to the instruction, and operates the speaker 38 to output the sound. Subsequently, when remote operations for the image processing apparatus 10 have been completed, the control section terminates the wireless communication with the image processing apparatus 10 (S105), and ends a series of processes.

Here, with regard to timing to terminate the wireless communication with the image processing apparatus 10, a switch to instruct an operation end or a switch to return to the application list screen may be arranged on the UI operation screen. Then, the control section may terminate the wireless connection with the image processing apparatus 10 in response to a user's operation on such the switch. Further, when a remote operation has not been performed for a predetermined time period, the control section may also terminate the wireless communication with the image processing apparatus 10.

Next, the actions of the image processing apparatus 10 of the present example is described with reference to a flowchart shown in FIG. 5 and a schematic diagram sown in FIGS. 7A to 7D. In the control section of the image processing apparatus 10, the CPU 11 is configured to execute a control program stored in the memory section 14, such as the ROM 12 and the HDD, thereby realizing the processing of the flowchart shown in FIG. 5.

The control section of the image processing apparatus 10 establishes wireless communication with the remote terminal 30 (illustration is omitted), and sends information of the UI operation screen to the remote terminal 30 (S201). Upon detection of an operation on the UI operation screen, the control section of the image processing apparatus 10 section judges whether the UI operation is operated on the UI operation screen of the remote terminal 30 (S202). Then, in the case where the UI operation is judged as the operation on the UI operation screen of the display section 21 of the image processing apparatus 10, the control section executes a process corresponding to the UI operation. At this time, as shown in FIG. 7A, in a standby state of the apparatus (a state for waiting wireless connection with the remote terminal 30), the output setting of the speaker 23 of the image processing apparatus 10 is set to ON, and the output setting is still maintained after the connection. Accordingly, as shown in FIG. 7B, a sound (for example, a FAX communication sound, an operation sound, a process completion notification sound, a guidance voice, and the like) to be outputted at the time of executing a process corresponding to the UI operation on the display section 21 of the image processing apparatus 10 is outputted from the speaker 23 (S203).

On the other hand, in the case where the UI operation is judged as the operation on the UI operation screen of the remote terminal 30 (YES at S202), the control section transfers the sound data to be outputted from the speaker 23 to the remote terminal 30 in which the UI operation has been performed, to output the sound through the speaker 38, and if needed, executes control to turn off the output setting of the speaker 23 of the image processing apparatus (S204). As a result, as shown in FIG. 7C, there is provided a control to operate the remote terminal 30 having performed the UI operation to output the sound to be outputted at the time of executing a process corresponding to the UI operation, and if needed, to operate the image processing apparatus 10 not to output the sound.

Subsequently, as shown in FIG. 7D, when the control section detects that the remote terminal 30 has terminated the remote operation (YES at S205), the control section turns on the output setting of the speaker 23, and removes the sound output prohibiting state in the image processing apparatus 10 (S206).

Incidentally, during the image processing apparatus 10 is executing a process (for example, a copy process) instructed on the UI operation screen of the image processing apparatus 10 in addition to a process (for example, a FAX process) instructed on the UI operation screen of the remote terminal 30 (in other words, when the image processing apparatus 10 is executing plural processes in parallel), the control section may control the speaker 23 to output the sound corresponding to the process (for example, the copy process) other than the process (for example, the FAX process) instructed by the remote terminal 30 in place of the control to turn off the output setting of the speaker 23 of the image processing apparatus 10. That is, the control section may control the speaker 23 not to output the sound corresponding to a process instructed by the remote terminal 30 while controlling the speaker 23 to output the sound corresponding to a process instructed on the UI operation screen of the image processing apparatus 10.

In this way, in the image processing system of the present example, with the control to operate the speaker 38 of the remote terminal 30 output the sound corresponding to a process, even in the case where a user being currently operating the remote terminal 30 is at a place separated from the image processing apparatus 10, the user can grasps surely the state of a process executed in the image processing apparatus 10. As a result, it becomes possible to omit time and labor to confirm the state of a process by going to the image processing apparatus 10, thereby improving the convenience of a user. Further, with the control to operate the speaker 23 of the image processing apparatus 10 not to output the sound corresponding to a process instructed by the remote terminal 30, it becomes possible to prevent beforehand confusion caused by the sounds outputted from both of the remote terminal 30 and the image processing apparatus 10. Furthermore, it becomes also possible to stop bothering a user being near to the image processing apparatus 10, thereby improving the convenience of a user.

### Second Example

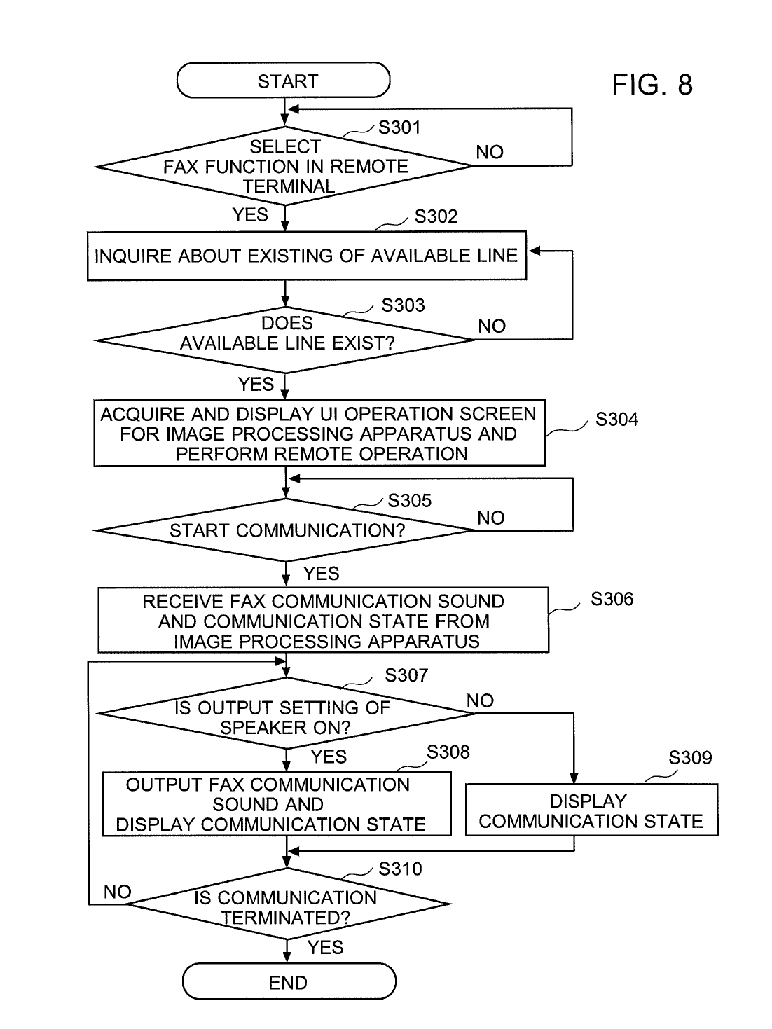

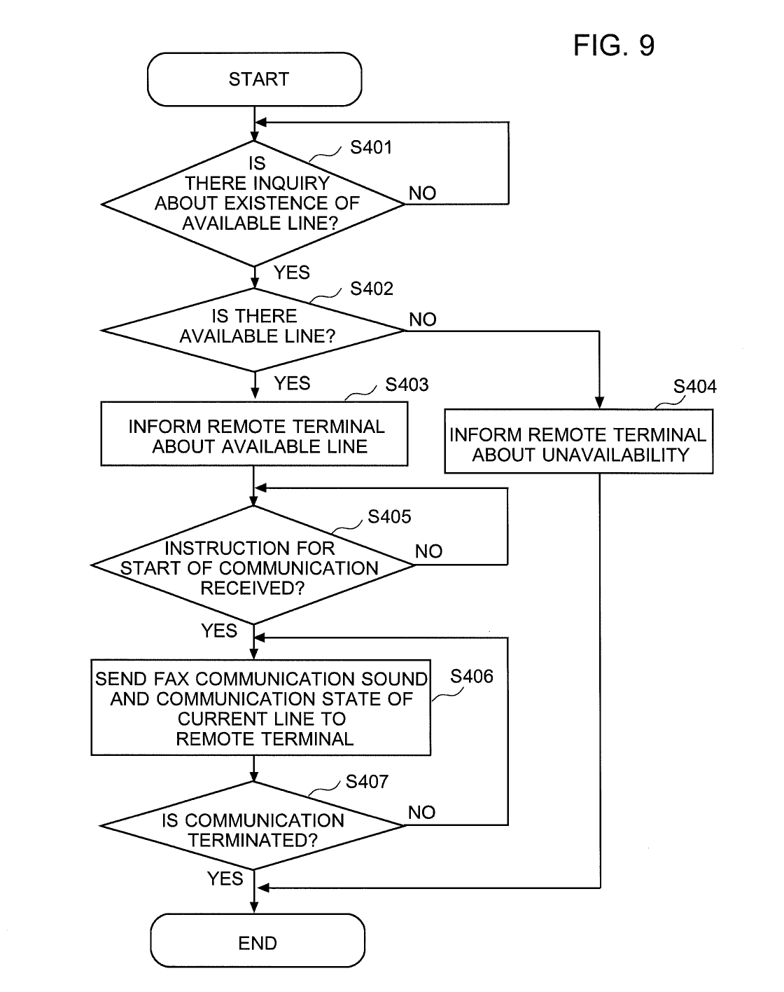

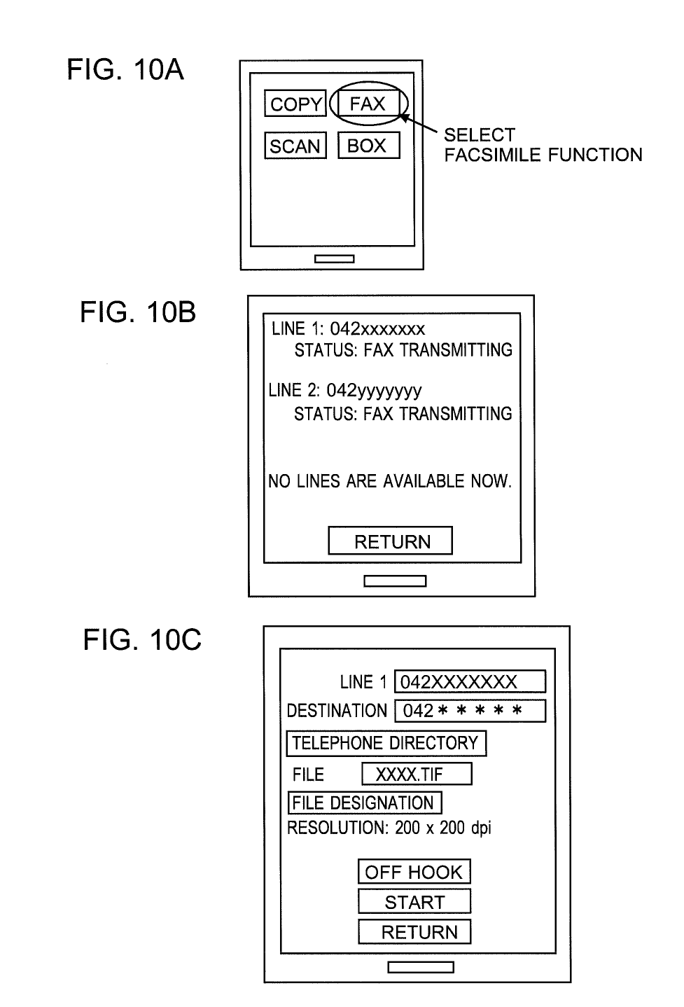

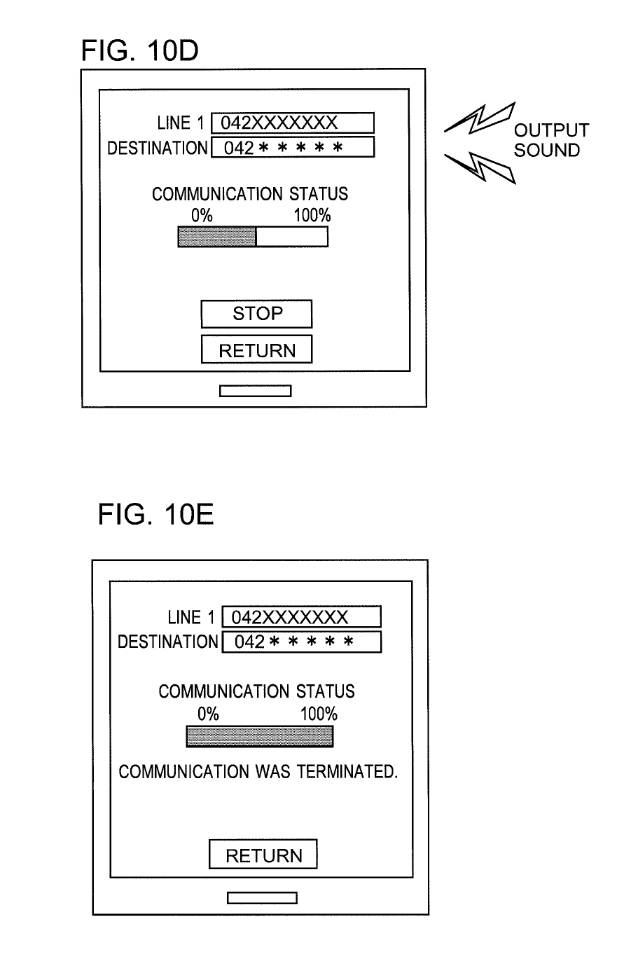

Next, description will be given to an image processing system, an image processing apparatus, and a remote terminal in relation to the second example with reference to FIGS. 8 to 12. Further, FIGS. 8 and 9 are flowcharts showing processing of the remote terminal and the image processing system respectively, and FIGS. 10A to 12 are illustrations showing schematically processing of the remote terminal and the image processing system respectively.

In the above-mentioned first example, with the control to operate the remote terminal 30 to output the sound to be outputted from the speaker 23 of the image processing apparatus 10, even in the case where a user is at a place separated from the image processing apparatus 10, the user is enabled to grasp the state of a process executed at the image processing apparatus 10. However, only with the sound, there may be a case where a user may not grasp sufficiently the detailed state of a process executed in the image processing apparatus 10. For example, when performing FAX transmission, the situation of the FAX transmission (a degree of progress in the FAX transmission) can be displayed on the display section 21. However, in the first example, a user cannot confirm visually the situation of the FAX transmission at the remote terminal 30, which makes the user difficult to fully grasp the detailed situation of the process. Then, in this example, there is provided a control to operate the display section 36 of the remote terminal 30 to display a screen like a screen displayed on the display section 21 of the image processing apparatus 10 in response to execution of a process.

In this control, the basic constitution of each of the image processing apparatus 10 and the remote terminal 30 is the same as that shown in each of FIGS. 2 and 3 respectively in the first example. However, in response to receiving an instruction for a process from the UI operation screen displayed on the image processing apparatus 10, the control section of the image processing apparatus 10 controls the speaker 23 to output a sound and a voice corresponding to the process and the display section 21 of the image processing apparatus 10 to display a screen to notify the situation of the process, or controls the display section 21 of the image processing apparatus 10 to display a screen to notify the situation of the process in place of the controlling of the speaker 23 to output a sound and a voice. Further, in response to receive an instruction for a process through the UI operation screen of the remote terminal 30, the control section of the image processing apparatus 10 transfers the sound data corresponding to the process and information of a screen to notify the situation of the process to the remote terminal 30 or transfers information of a screen to notify the situation of the process to the remote terminal 30 in place of the sound data. Successively, the control section of the remote terminal 30 controls the speaker 38 to output the sound and the voice corresponding to the process and the display section 36 to display a screen based on the received information or controls the display section 36 to display a screen based on the received information in place of the controlling of the speaker 38 to output sound and voice. That is, in the present example, the display section and the speaker of each of the image processing apparatus 10 and the remote terminal 30 work as an output section to output a notice.

Hereafter, the actions of the image processing system of the present example will be described. First, the actions of the remote terminal 30 of the present example are described with reference to a flowchart shown in FIG. 8 and a schematic diagrams shown in FIGS. 10A to 10E. In the control section of the remote terminal 30, the CPU 31 is configured to execute a control program stored in the memory section 34, such as the ROM 32 and the HDD, thereby realizing the processing of the flowchart shown in FIG. 8.

A user operates the operating section 37 so as to start the application for the image processing apparatus. For example, as same as the first example, the operating section 37 controls the display section 36 to display an application list screen, and, as shown in FIG. 10A, the user selects a function to be executed in the image processing apparatus 10 (in the present example, a FAX function enclosed with the circle in FIG. 10A) from the application list. Then, when detecting that the FAX function has been selected (YES at S301), the control section of the remote terminal 30 inquires the image processing apparatus 10 whether an available line exists (S302).

When an available line does not exist (NO at S303), the control section receives from the image processing apparatus 10 the screen information in which the usage situation of each line and a message to notify the nonexistence of an available line are described, and controls the display section 36 to display the screen (refer to FIG. 10B). On the other hand, when an available line exists (YES at S303), the control section receives from the image processing apparatus 10 the information of a setup screen with regard to a process to be executed in the image processing apparatus 10 by using the available line, and controls the display section 36 to display the setup screen (refer to FIG. 10C) (S304).

Successively, the control section 37 allows the user to set the destination (select from a telephone directory, or input a telephone number directly) and set a file to be transmitted via FAX (select from a list, or input a file name directly) by operating the operating section 37. Subsequently, when the user instructs to start communication by depressing a “START” button on the setup screen, the control section starts communication with the image processing apparatus 10 (YES at S305), and receives sound data of the FAX communication and screen information of the communication state from the image processing apparatus 10 (S306).

Next, the control section judges about the output setting of the speaker 38 (S307). When the output setting of the speaker 38 is set to ON, as shown in FIG. 10D, the control section controls the speaker 38 to output the FAX communication sound and also controls the display section 36 to display the screen of the communication state (S308). On the other hand, when the output setting of the speaker 38 is set to OFF, the control section controls the display section 36 to display the screen of the communication state (S309). Successively, the control section monitors the FAX communication (S310), returns to S307 until the FAX communication is ended, and continues and/or renews the output of the FAX communication sound and the display of the communication state. Subsequently, as shown in FIG. 10E, when the FAX communication has been ended, the control section ends a series of processes. Here, the output setting of the speaker 38 is turned on or off beforehand by the user of the remote terminal

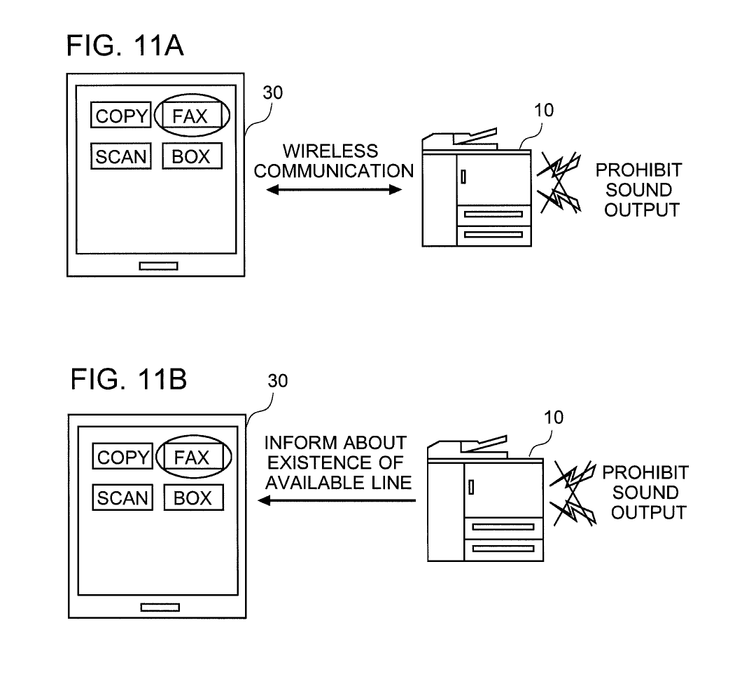

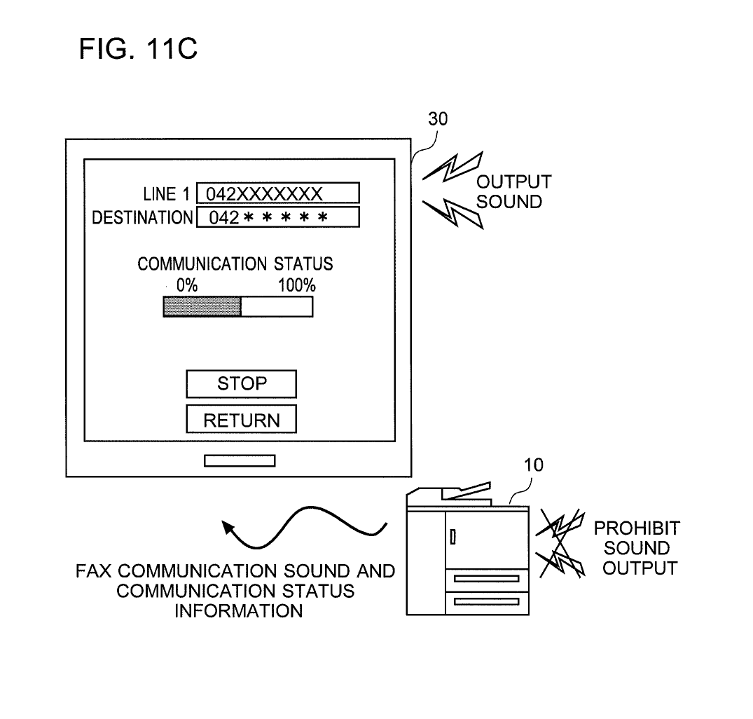

Next, the actions of the image processing apparatus 10 of the present example is described with reference to a flowchart shown in FIG. 9 and a schematic diagram sown in FIGS. 11A to 11C. In the control section of the image processing apparatus 10, the CPU 11 is configured to execute a control program stored in the memory section 14, such as the ROM 12 and the HDD, thereby realizing the processing of the flowchart shown in FIG. 9.

As with the first example, the control section of the image processing apparatus 10 establishes wireless communication with the remote terminal 30 (illustration is omitted). Upon detection of an operation on the UI operation screen, the control section judges whether the UI operation has been operated on the UI operation screen of the remote terminal 30. Then, in the case where the UI operation has been operated on the UI operation screen of the display section 21 of the image processing apparatus, the control section executes a process corresponding to the UI operation. At this time, the control section controls the speaker 23 to output the sound (for example, a FAX communication sound, an operation sound, a process completion notification sound, a guidance voice, and the like) to be outputted at the time of executing a process corresponding to the UI operation on the display section 21 of the image processing apparatus, and controls the display section 21 to display a screen to notify the situation of the process. In concrete terms, in the case where a FAX transmission is instructed in the image processing apparatus, the control section controls the speaker 23 to output the FAX notification sound to be processed based on the instruction, and simultaneously controls the display section 21 to display the screen (for example, the screen as shown in FIG. 10D) to indicate the execution state of the FAX communication.

On the other hand, in the case where the UI operation has been an operation (in the present example, an instruction for a FAX transmission) performed on the UI operation screen of the remote terminal 30, as shown in FIG. 11A, if needed, the control section turns off the output setting of the speaker 23 of the image processing apparatus. Further, for preventing a user from performing operations at the side of the image processing apparatus 10 during a remote operation is being performed from the remote terminal 30, if needed, the control section turns off the display setting of the display section 21 of the image processing apparatus.

Next, when the control section receives from the remote terminal 30 an inquiry as to whether an available line exists (YES at S401), the control section judges whether an available line exists (S402), and inform about the existence or nonexistence of an available line to the remote terminal 30 as shown in FIG. 11B. When there is no available line, the control section sends the remote terminal 30 screen information of a screen on which the usage situation of each line and a message to notify the nonexistence of a usable line are described to inform about unavailability of lines (S404), and the control section ends a series of processes.

On the other hand, when there is an available, the control section sends the setup screen information to use an available line to the remote terminal 30 (S403). Then, upon receipt of an instruction for start of FAX communication from the remote terminal 30 (YES at S405), as shown in FIG. 11C, the control section transmits the sound data of the FAX communication sound of a line currently being used in accordance with the instruction from the remote terminal 30 and the information of a screen to notify a communication state to the remote terminal 30 (S406). Successively, the control section monitors the completion of the FAX communication (S407), returns to 5406 until the FAX communication is ended, and sends the sound data of the FAX communication sound and the information of the screen of the communication state to the remote terminal 30. Subsequently, when the FAX communication has been ended, the control section ends a series of processes.

Also in the present example, during the image processing apparatus 10 is executing a process (for example, a copy process) instructed on the UI operation screen of the image processing apparatus 10 in addition to a process (for example, a FAX process) instructed on the UI operation screen of the remote terminal 30 (in other words, when the image processing apparatus 10 is executing plural processes in parallel), the control section may control the speaker 23 to output the sound corresponding to the process (for example, the copy process) other than the process (for example, the FAX process) instructed by the remote terminal 30 in place of the control to turn off the output setting of the speaker 23 of the image processing apparatus 10. That is, the control section may control the speaker 23 not to output the sound corresponding to a process instructed by the remote terminal 30 while controlling the speaker 23 to output the sound corresponding to a process instructed on the UI operation screen of the image processing apparatus 10. Similarly, the control section may control the display section 21 to display the screen corresponding to the process (for example, a copy process) other than the process (for example, a FAX process) instructed by the remote terminal 30 without turning off the display section 21 of the image processing apparatus 10. That is, the control section may control the display section 21 not to display the screen corresponding to a process instructed by the remote terminal 30 while controlling the display section 21 to display the screen corresponding to a process instructed on the UI operation screen of the image processing apparatus 10. In more concrete terms, when FAX transmissions are instructed by the image processing apparatus 10 and the remote terminal 30 by using different communication lines, the control section may control the display section 21 not to display a screen to indicate the execution state of the FAX transmission with regard to an instruction from the remote terminal 30 while controlling the display section 21 to display a screen to indicate the execution state of the FAX transmission with regard to an instruction from the image processing apparatus 10.

In this way, in the image processing system of the present example, the display section 36 of the remote terminal 30 is controlled to display a screen corresponding to a process instructed on the UI operation screen of the remote terminal 30, and the speaker 38 is controlled to output a sound corresponding to the process. With the above control, even in the case where a user being currently operating the remote terminal 30 is at a place separated from the image processing apparatus 10, the user can grasp surely the state of a process executed at the image processing apparatus 10. As a result, it becomes possible to omit time and labor to confirm the state of a process by going to the image processing apparatus 10, thereby improving the convenience of a user. Further, with the control to make the speaker 23 of the image processing apparatus 10 not to output the sound corresponding to a process instructed by the remote terminal 30, it becomes possible to prevent beforehand confusion caused by the sounds output from both of the remote terminal 30 and the image processing apparatus 10. Furthermore, it becomes also possible to stop bothering a user being near to the image processing apparatus 10, thereby improving the convenience of a user.

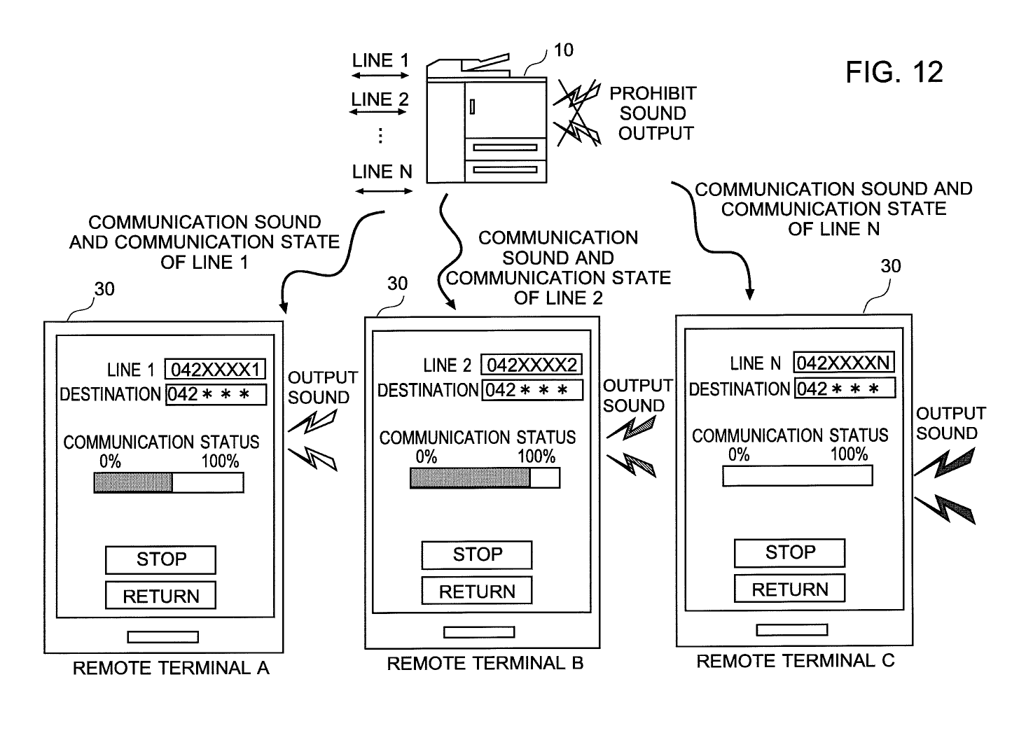

In the above-mentioned examples, description is given to the case where a single remote terminal 30 performs a remote operation for the image processing apparatus 10. However, the examples are also applicable to the case where a plurality of remote terminals 30 performs respective remote operations for the image processing apparatus 10. For example, as shown in FIG. 12, under the situation that there are a plurality of communication lines (here, N communication lines, where N is a natural number) capable of performing FAX communications separately, when a plurality of remote terminals 30 (here, N remote terminals) are performing respective remote operations via the respective different communication lines, and thereby the image processing apparatus 10 executes plural processes, each of the plurality of remote terminals 30 can be controlled so as to output a FAX communication sound corresponding to an in-use communication line and to display the notification screen of a communication state corresponding to the in-use communication line.

In concrete terms, the control section of the image processing apparatus 10 transfers only a notice corresponding to a process to the remote terminal 30 which has given the instruction for the process. Thereby, this control section of the remote terminal 30 operates the output section thereof not to output a notice or notices corresponding to processes except the process executed in response to the instruction received through its own operating section. That is, the control terminal operates a remote terminal A to output only the FAX communication sound of the in-use communication line 1 and to display only the notification screen of the communication state of the in-use communication line 1. Further, the control section operates each of a remote terminal B and a remote terminal C not to output the FAX communication sound and the notification screen of the communication state in relation to the in-use communication line 1. Successively, the control section controls the remote terminal B to output the FAX communication sound and the notification screen of the communication state in relation to the in-use communication line 2, and the remote terminal C is controlled to output the FAX communication sound and the notification screen of the communication state in relation to the in-use communication line 4. With the execution of the above-mentioned control, even in the case where remote operations for the image processing apparatus 10 are performed by use of a plurality of remote terminals 30, it becomes possible to prevent beforehand a user from causing confusion between a notice with regard to a process instructed by a remote terminal being used by the user oneself and a notice with regard to a process instructed by another remote terminal, thereby improving the convenience of the user.

The present invention should not be limited to the above-mentioned examples. The constitution and control method of the present invention may be changed appropriately, unless the changes deviate from the intention of the present invention.

For example, each of the above-mentioned examples is constituted to output a sound and to display a screen on the remote terminal 30 based on the sound data and screen information acquired from the image processing apparatus 10. However, the remote terminal 30 may be configured to acquire information indicating the state of a process from the image processing apparatus 10, to create a sound and a screen based on the information, to output the sound created by the remote terminal 30, and to display the screen created by the remote terminal 30.

Further, each of the above-mentioned examples is constituted to perform a remote operation by displaying the UI operation screen provided from the image processing apparatus 10 on the remote terminal 30. However, in the case where a remote operation is performed on an operation screen created by the remote terminal 30 itself, the control of the present invention can be applied similarly by transmitting instruction information corresponding to the remote operation to the image processing apparatus 10.

Furthermore, in each of the above-mentioned embodiments, description is given to the case where the remote terminal 30 performs a remote operation for an apparatus such as a FAX apparatus and a MFP. However, the control of the present examples can be applied similarly to the case where a remote operation is performed for an arbitral apparatus which outputs a sound and displays a screen in accordance with a process.

1. An image processing system comprising:
an image processing apparatus and at least one remote terminal which can perform a remote control for the image processing apparatus,
the image processing apparatus comprising
a control section configured to execute a plurality of processes,
an operating section configured to receive instructions for the processes and
an output section configured to output a notice corresponding to each of the processes,
the remote terminal comprising
an operating section configured to receive instructions for processes to be executed in the image processing apparatus,
an output section configured to output a notice corresponding each of the processes, and
a control section,
wherein the control section of the image processing apparatus is configured to, on the control section of the image processing apparatus executing a process in response to an instruction received through the operating section of the image processing apparatus, operate the output section of the image processing apparatus to output a notice corresponding to the process executed in response to the instruction received through the operating section of the image processing apparatus, and
the control section of the image processing apparatus and the control section of the remote terminal are configured to, on the control section of the image processing apparatus executing a process in response to an instruction received through the operating section of the remote terminal,
operate the output section of the remote terminal to output a notice corresponding to the process executed in response to the instruction received through the operating section of the remote terminal, and
operate the output section of the image processing apparatus not to output the notice corresponding to the process executed in response to the instruction received through the operating section of the remote terminal or operate the output section of the remote terminal not to output a notice corresponding to a process other than the process executed in response to the instruction received through the operating section of the remote terminal.

2. The image processing system of claim 1,
wherein the control section of the image processing apparatus is configured to, on executing a plurality of processes in parallel, operate the output section of the image processing apparatus to output a notice or notices corresponding to the plurality of processes except the process executed in response to the instruction received through the operating section of the remote terminal.

3. The image processing section of claim 1,
wherein the image processing system includes a plurality of the remote terminals,
the control section of each of the remote terminals is configured to, on the plurality of remote terminals performing remote operations for the image processing apparatus, operate the output section of the each of the remote terminals to output only a notice corresponding to a process executed in response to an instruction received through the operating section of the each of the remote terminals.

4. The image processing section of claim 1,
wherein the control section of the image processing apparatus is configured to send information of an operating screen of the image processing apparatus to the remote terminal, and
the control section of the remote terminal is configured to perform a remote operation for the image processing apparatus according to a user's operation performed on the operation screen by using the operating section of the remote terminal.

5. The image processing section of claim 1,
wherein the notice outputted corresponding to a process is at least one of a sound outputted according to process and a screen displayed according to the process.

6. The image processing section of claim 5,
wherein the sound outputted according to process is one of an operation sound, a facsimile communication sound, a process completion notification sound and a guidance voice.

7. An image processing apparatus which can connect with at least one remote terminal for performing a remote operation for the image processing apparatus,
the image processing apparatus comprising:
a control section configured to execute a plurality of processes,
an operating section configured to receive instructions for the processes and
an output section configured to output a notice corresponding to each of the processes,
wherein the control section is configured to,
on executing a process in response to an instruction received through the operating section, operate the output section to output a notice corresponding to the process executed in response to the instruction received through the operating section, and
on executing a process in response to an instruction received from the remote terminal, operate the remote terminal to output a notice corresponding to the process executed in response to the instruction received from the remote terminal, and operate the output section not to output the notice corresponding to the process executed in response to the instruction received from the remote terminal.

8. The image processing apparatus of claim 7,
wherein the control section is configured to, on executing a plurality of processes in parallel, operate the output section to output a notice or notices corresponding to the plurality of processes except the process executed in response to the instruction received from the remote terminal

9. The image processing apparatus of claim 7,
wherein the control section is configured to, on a plurality of the remote terminals executing remote operations for the image processing apparatus, transfer only a notice corresponding to a process executed in response to an instruction received from one of the remote terminals to the one of the remote terminals having given the instruction.

10. The image processing apparatus of claim 7,
wherein the control section is configured to
send information of an operation screen of the image processing apparatus to the remote terminal and
receive, from the remote terminal, an instruction for a remote operation performed by using the operation screen.

11. The image processing apparatus of claim 7,
wherein the notice outputted corresponding to a process is at least one of a sound outputted corresponding to the process and a screen displayed corresponding to the process.

12. The image processing apparatus of claim 11,
wherein the sound outputted corresponding to the process is one of an operation sound, a facsimile communication sound, a process completion notification sound and a guidance voice.

13. A remote terminal which can perform a remote control for an image processing apparatus, the image processing apparatus being configured to execute a plurality of processes and including an output section configured to output a notice corresponding to each of the processes, the remote terminal comprising
an operating section configured to receive instructions for processes to be executed in the image processing apparatus,
an output section configured to output a notice corresponding each of the processes, and
a control section configured to, on the image processing apparatus executing a process in response to an instruction received through the operating section, acquire a notice corresponding to the process from the image processing apparatus and operate the output section of the remote terminal to output the notice.

14. The remote terminal of claim 13,
wherein the control section is configured to, on the image processing apparatus executing a plurality of processes in parallel, operate the output section of the remote terminal not to output a notice or notices corresponding to the plurality of processes except the process executed in response to the instruction received through the operating section.

15. The remote terminal of claim 13,
wherein the control section is configured to acquire information of an operating screen from the image processing apparatus and perform a remote operation for the image processing apparatus according to a user's operation performed on the operation screen by using the operating section.

16. The remote terminal of claim 13,
wherein the notice outputted corresponding to a process is at least one of a sound outputted corresponding to the process and a screen displayed corresponding to the process.

17. The remote terminal of claim 16,
wherein the sound outputted corresponding to the process is one of an operation sound, a facsimile communication sound, a process completion notification sound and a guidance voice.
